(19) United States
(12) Patent Application Publication
(10) Pub. No.: US 2014/0297541 A1
(43) Pub. Date: Oct. 2, 2014

(54) ID Authentication

(71) Applicant: Technology Business Management Limited, Wilmslow (GB)

(72) Inventor: Tarlok Nath Teji, Harrogate (GB)

(73) Assignee: Technology Business Management Limited, Wilmslow (GB)

(21) Appl. No.: 14/251,248

(22) Filed: Apr. 11, 2014

Related U.S. Application Data
(63) Continuation of application No. PCT/GB2012/000776, filed on Oct. 11, 2012.

(30) Foreign Application Priority Data
Oct. 12, 2011 (GB) 1117641.9

(51) Int. Cl. G06Q 20/40; G06Q 20/38

(52) U.S. Cl. CPC G06Q 20/4012; G06Q 20/382
USPC 705/72

(57) ABSTRACT

A secure ID authentication system for authenticating over the Internet network a response from a user module such as an Internet-enabled mobile phone or a computer to a request from an application-programming interface (API) to authenticate a transaction, in which; a PIN request is sent to the user module which displays an “enter pin” prompt; the user module encodes a message comprising its user ID and the PIN using a first code and transmits the thus encoded message to an identity application server (IAS) which has a database of user IDs and associated PINs; the IAS encodes the received message using a second code and transmits the thus twice encoded message back to the user module; the user module part decodes the now twice encoded message by reversing the first code and transmits the part decoded message back to the IAS: the IAS fully decodes the message by reversing the second code; the IAS checks the fully decoded message against the database to confirm or otherwise that it holds the combination user ID and PIN; and if it is confirmed, the ISA sends a “PIN authenticated” message to the API.

### FIELD OF THE INVENTION

This invention relates to secure ID authentication procedures, particularly, but not exclusively, for authenticating financial and other transactions over publicly accessible communications networks such as cellular telephone networks.

### BACKGROUND OF THE INVENTION

An accepted authentication procedure for credit and debit card transactions involves the use of a PIN—a personal identification codes, usually consisting of a four digit number, such as 7356—that is known, or supposed to be known, only to the card holder. Not even the issuing bank or card company knows the user's PIN.

A payment card PIN is held on the card as an element of data in a magnetic strip. At a payment terminal connected in a communications network, the terminal reads the PIN from the magnetic strip and requests the user to enter the PIN on a keypad. If they match, the transaction is authenticated. In this instance, there is no transmission of the PIN over the network. The module simply confirms that the payment is authorised.

However, in many other transactions between a user and a service module, which do not use a dedicated payment terminal with a facility for checking an entered PIN, the PIN would need to be stored on the service module, and checked there in order to authenticate the transaction.

The PIN is vulnerable, however, to discovery when transmitted over a publicly accessible network. Knowledge of the PIN could enable unauthorised access to the PIN holder's accounts and other restricted access information. It has been proposed to improve security by more complex procedures.

A common approach is to require a two-part identity check, one part being specific to the instrument used to transmit the information to the service module, the other part being specific to the user. If the instrument is a mobile phone, a combination of phone ID and user ID is required. The phone will have a unique ID, being, of course, the telephone number as it appears on the SIM card. The industry mandates that there is only ever one SIM card with any particular number. The user ID input might be the user's PIN number.

However, transmitting this information over a network is open to the risk of eavesdropping. It does not matter that the SIM card ID is unique—it is only required to record and re-use the data stream to access the service module.

Simply encrypting the information is no help. It would, in any event, be the encoded information that is intercepted. It is not necessary to de-encrypt it, just use it in the encrypted format, to gain access.

Resort is had, therefore, to a one-time password. Interception is now pointless, as the same data stream will not work a second time.

Examples of one-time password systems are found in WO2010/101476, WO0131840, and numerous other patent publications.

However, one-time passwords require software on the user module to generate them, and corresponding software on the service module to verify them, and, in order to provide acceptable levels of security, the software and its usage are sometimes made deliberately complex, in some instances requiring time-limited passwords and random number generators, or costly ancillary equipment.

### BRIEF DESCRIPTION OF THE INVENTION

The present invention provides a method for secure ID authentication that can be implemented for transactions effected over the Internet that is simpler and more straightforward than the systems referred to above.

The invention comprises a secure ID authentication system for authenticating over the Internet network a response from a user module such as an Internet-enabled mobile phone or a computer to a request from an application-programming interface (API) to authenticate a transaction, in which;

a PIN request is sent to the user module which displays an “enter pin” prompt;

the user module encodes a message comprising its user ID and the PIN using a first code and transmits the thus encoded message to an identity application server (IAS) which has a database of user IDs and associated PINs;

the IAS encodes the received message using a second code and transmits the thus twice encoded message back to the user module;

the user module part decodes the now twice encoded message by reversing the first code and transmits the part decoded message back to the IAS:

the IAS fully decodes the message by reversing the second code;

the IAS checks the fully decoded message against the database to confirm or otherwise that it holds the combination user ID and PIN; and

if it is confirmed, the ISA sends a “PIN authenticated” message to the API.

The “PIN authenticated” message may be sent direct to the API or through the user module, and may, in either case, be sent also by a double key encoding system.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in Which:

FIG. 1 is a block diagram; and

FIG. 2 is a flow chart.

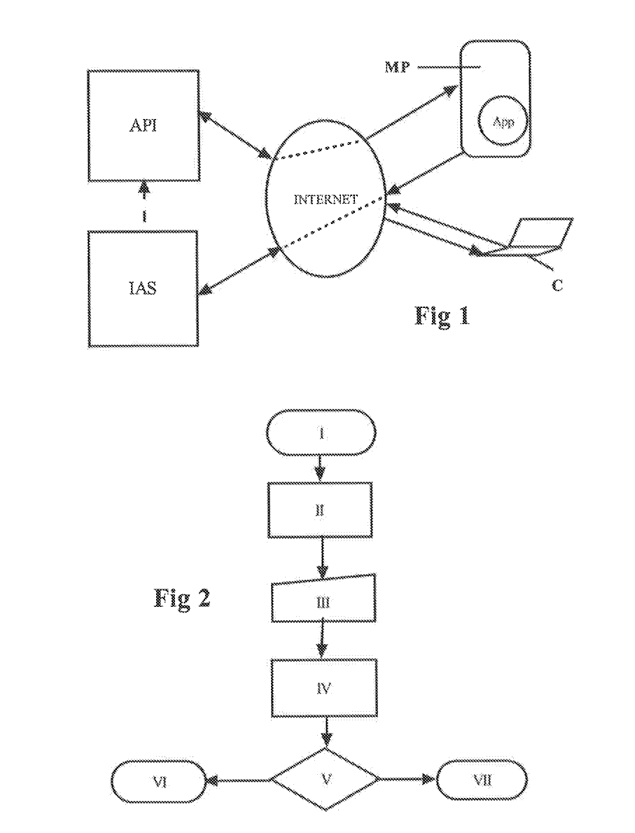

### DETAILED DESCRIPTION OF THE INVENTION

A secure ID authentication system will now be described with reference to the accompanying drawings.

The drawings illustrate a secure ID authentication system for authenticating over the Internet network a response from a user module such as an Internet-enabled mobile phone MP or a computer C to a request from an application-programming interface (API) to authenticate a transaction, in which;

a PIN request—Step 1, FIG. 2—is sent to the user module, MP, C, which displays an “enter pin” prompt—Step II—so that a PIN is entered—Step III;

the user module MP, C, transmits—Step IV using a double key encoding system a message comprising its user ID and the PIN to an identity application server (ISA) which has a database of user IDs and associated PINs;

the IAS—Step V—checks the message against the database to confirm or otherwise that it holds the combination user ID and PIN; and

if it is confirmed, the ISA, sends a “PIN authenticated” message to the API and terminates the operation—Step VI.—or sends a “PIN incorrect” message and terminates the operation—Step VII.

This is a simple method by which a transaction can be PIN verified, and can be used for financial transactions such as credit and debit card payments, bank payments and transfers and balance enquiries.

In addition to facilitating secure financial transactions, the system can provide secure access to a personal database that might be kept in the API. The database might a virtual vault that securely stores personal data such as birth certificate and passport details, purchase records, from which a personal profile might be built up which could be selectively available to retailers, who might thereby recommend products and services, an address book, clearly, and a CV, as well as driving license and insurance details. All this could be securely accessed by, and added to or changed, from a mobile phone or like device.

1. A secure ID authentication system for authenticating over the Internet network a response from a user module such as an Internet-enabled mobile phone or a computer to a request from an application-programming interface (API) to authenticate a transaction, in which;
a PIN request is sent to the user module which displays an “enter pin” prompt;
the user module encodes a message comprising its user ID and the PIN using a first code and transmits the thus encoded message to an identity application server (IAS) which has a database of user IDs and associated PINs;
the IAS encodes the received message using a second code and transmits he thus twice encoded message back to the user module;
the user module part decodes the now twice encoded message by reversing the first ode and transmits the part decoded message back to the IAS;
the IAS fully decodes the message by reversing the second code;
the IAS checks the fully decoded message against the database to confirm or otherwise that it holds the combination user ID and PIN; and
if it is confirmed, the ISA sends a “PIN authenticated” message to the API.

2. A system according to claim 1, in which the “PIN authenticated” message is sent direct to the API.

3. A system according to claim 1, in which the “PIN authenticated” message is sent to the API via the user module.

4. A system according to claim 1, when used for authenticating financial transactions.

5. A system for the secure storage of data, such as personal data, comprising an access system comprising a secure ID authentication system according to claim 1.
